(19) United States
(12) Patent Application Publication
(10) Pub. No.: US 2012/0009400 A1
(43) Pub. Date: Jan. 12, 2012

(54) WINDABLE TILE DESIGN, METHOD FOR MANUFACTURING AND USE

(76) Inventors: Marcel Nauer, Oberageri (CH); Alex Kummer, Laufen (CH); Stefan Brand, Hirschberg-Leutershausen (DE); Hubert Liebe, Wiesbaden (DE); Norman Blank, Ruschilkon (CH); Urs Erb, Bettlach (CH); Harald Jenny, Schaffhausen (CH)

(21) Appl. No.: 13/121,101

(22) PCT Filed: Oct. 6, 2009
(86) PCT No.: PCT/EP09/62925

§ 371 Date: Sep. 27, 2011

(30) Foreign Application Priority Data
Oct. 10, 2008 (EP) 08166341.1

(51) Int. Cl. B32B 7/02; E04F 13/077; C08G 77/26; B32B 5/22; B32B 15/08; B32B 18/00; B32B 17/10; B32B 23/08; B32B 38/08; B32B 27/08

(52) U.S. Cl. 428/215; 156/278; 156/71; 156/182; 528/38; 428/446; 428/448; 428/450; 428/452; 428/428; 428/412; 442/59

(57) ABSTRACT

The invention relates to a rollable tile structure, to a process for the production of the tile structure, and to the use of the tile structure in the production of a tiled covering. The invention relates further to the use of organic polysilazanes in the production of a rollable tile structure. The tile structure has a first carrier layer (1) and a surface layer (2), the surface layer (2) comprising a network of organic polysilazanes and the tile structure as a whole being in rollable form.

The invention relates to a rollable tile structure, to a process for the production of the tile structure, and to the use of the tile structure in the production of a tiled covering. The invention relates further to the use of organic polysilazanes in the production of a rollable tile structure.

Tiles, such as, for example, ceramic tiles, are available commercially in a large number of different variations. They differ by their structure, by the materials from which they are produced, and by their properties.

Ceramic tiles generally consist of a mixture of kaolin, feldspar, quartz and clay, which is covered with a ceramic coating, in some cases printed with patterns and in some cases provided with texturing. The various ceramic tiles are classified, for example, into tiles for inside walls, floor, ceiling, kitchen and bathroom tiles, tiles for outside walls and industrial ceramic tiles on the basis of the materials and production conditions used.

Furthermore, non-flexible and non-rollable ceramic tiles having special properties are known from the prior art. For example, ceramic tiles having nano-sealed surfaces are described on various websites, such as “www.nanooberflaechenschutz.de”. The resistance of such functional surfaces is often very low, for which reason they are easily worn away in particular by abrasives and can be released into the environment.

A variant of non-flexible, non-rollable ceramic tiles that has appeared to an increased extent in recent years is tiles which have self-cleaning, anti-graffiti and/or antimicrobial action. Such ceramic tiles are marketed, for example, under the name “Hydrotect”.

A ceramic composite wall covering is known from WO 2005/080684 which consists of a carrier material and at least one ceramic coating, wherein a ceramic intermediate layer can optionally be present. The composite wall coverings of WO 2005/080684 are wallpapers which contain, in the ceramic coating, ceramic particles in a silicon-containing network which is linked by Si—O—Si bridges. The silicon-containing network of the ceramic coating is either a purely inorganic network, which is formed via the oxygen bridges, or an inorganic-organic network in which the organic radicals are bonded to the silicon. In order to produce the network, ceramic particles are suspended in a polymeric sol, which can be prepared by mixing at least one silane with an alcohol and an acid. The suspension is applied to the carrier material and than solidified. Provided between the carrier material and the ceramic coating is a ceramic intermediate layer which is produced by a sol-gel process, the sol acting as an inorganic adhesive. Tiled coverings, in particular ceramic tiled coverings, and the associated tile structure which as a whole is flexible and rollable, are not described. The disadvantages of sol/gel coatings are sufficiently well known. For example, sol/gel coating systems have only a short life because of the necessary use of acidic or alkaline catalysts. In addition, the corresponding coating systems generally do not have sufficient adhesion to the substrate.

Coated articles of concrete are known from JP 2006150337. The concrete surface is provided with an intermediate layer of a slightly elastic material which can contain an epoxy resin, a urethane resin and/or an acrylic acid resin. The intermediate layer is coated with a surface layer of a polysilazane in order to obtain sufficient hardness of the coating. The surface coating is such that, if a crack forms in the carrier material of concrete, the coating is not damaged. The article produced in this way is neither flexible nor rollable but rigid and accordingly unsuitable for the production of a rollable tile material.

WO 2006/108503 discloses a method of improving the barrier properties of ceramic harrier layers. In order to improve the barrier effect for water vapour and gases in a flexible carrier material, a barrier layer of ceramic material is coated with a solution of perhydropolysilazane and subsequently cured to form a silicon oxide layer. Proposed as flexible carrier materials are plastics foils, plastics films or laminates with a plastics film, on which the ceramic barrier layer is deposited. Layers of Al₂O₃ or SiOₓ are described as barrier layers of ceramic material having a thickness of from 10 nm to 200 nm.

With regard to the intended uses of the proposed ceramic barrier layers, reference is made to U.S. Pat. No. 5,645,923, which describes gas barrier layers for packaging foils. Reference is further made to flexible ultrabarrier structures according to the prior art, as are required, for example, for flexible OLED displays or for organic photovoltaic structures. Reference is further made to barrier layers in the case of plastics foils. The person skilled in the art accordingly obtains from WO 2006/108503 the suggestion to use the proposed perhydropolysilazane coating in foil composites for packaging, in displays and in the photovoltaics field. There is no suggestion in these documents to use a layer composite in conjunction with perhydrosilazanes for tile structures. For that reason, there is no mention either of the properties that are absolutely essential for tiles, for example wear resistance, acid resistance, stain sensitivity and hardness. In fact, this document describes ceramic barrier layers in conjunction with plastics films.

U.S. Pat. No. 2,553,314 describes a method for rendering the surfaces of materials water-repellent. In this method, liquid methyl silicon amine compounds are applied to surfaces such as paper, cotton, wool, ceramic bodies, aluminium, etc. The use of organic polysilazanes as a surface coating for tile structures for the production of tiled coverings is not described. The specific requirements made of tiles, such as degree of hardness, wear resistance, acid resistance and stain sensitivity, are not discussed, nor are specific layer combinations for producing tile structures.

U.S. Pat. No. 6,383,642 describes transparent carrier materials having a hydrophobic or oleophobic coating which is formed by plasma CVD. Silicon compounds such as silanes, alkoxysilanes, fluorosilanes, siloxanes or silazanes are deposited in the vapour phase on a carrier material to form a surface coating, in order to achieve dirt and water resistance on a very wide variety of surfaces, for example on furniture, doors, glass-ceramic sheets, bathtubs and washbasins. Layer structures as are described according to the invention for the production of a rollable tile structure are not disclosed. For that reason, the specific properties of tile structures, such as, for example, the required degree of hardness, acid resistance, stain sensitivity, wear resistance, etc., are likewise not discussed.

Protective shells for missile radomes are known from U.S. Pat. No. 6,080,455, wherein a titanium-dioxide-containing polysiloxane layer, as coating, is placed over a quartz lining impregnated with a resin. The use of polysilazanes in the production of flexible rollable tile structures is not described.

A coating composition is known from JP 2000073012 which has anti-UV and water-repelling properties and can be used, for example, for rubber products. This is a polysilazane formulation containing amine radicals. The use of polysilazane surface layers in the production of tile structures is not suggested by this. It is obvious that rubber products must have completely different properties to tile structures.

Protective coatings are known from WO 2003/106190 which are used for documents such as credit cards, passes and other plastics cards. Textile materials, paper and/or plastics materials are provided with a protective coating containing ceramic materials as well as silanes and/or silazanes. The demands made of protective coatings for documents, on the one hand, and of the document materials, on the other hand, are of a completely different nature to the demands that are to be made of materials for tile structures, in particular as regards degree of hardness, acid resistance, wear resistance, etc. A further fundamental difference lies in the combinations of individual layer materials for the production of a rollable tile structure, which are not rendered obvious by WO 03/106190.

WO 2005/068181 describes photocatalytic particles for flooring laminates, the laminate containing binders which can be selected from a wide range of compositions including, for example, melamine resins, polyester resins, polyurethane resins, polysilane resins, polysiloxane resins, silazane resins, acrylamide resins, acrylic urethane resins and polyacrylamide resins, to name only a few. The laminate comprises a decorative outer layer, which optionally has a protective layer and a base layer, the decorative upper layer comprising a network of fibres in which the photocatalytically active particles are embedded in a binder. There are used as fibre materials, for example, cellulose fibres, as photocatalytic particles, for example, compounds such as titanium dioxide, iron(III) oxide, zinc oxide, etc. The use of organic polysilazanes in the production of rollable tile structures is not included in or suggested by this document. The specific properties required for tile structures, in particular maintenance of the necessary degrees of hardness and the combination of individual layers, are not discussed.

The field of use of modern ceramic tiles is becoming ever larger. In addition, owing to increasing demands in terms of ease of laying and renovating, ever more specific demands are being made of ceramic tiles. At the same time, the ceramic tiles are to be versatile in terms of design and markedly less expensive, in particular in terms of fitting. Accordingly, there is a constant need for novel ceramic tiles. Novel ceramic tiles should, where possible, be substantially easier to handle and nevertheless have good durability.

An object of the present invention is, therefore, to provide tile structures, in particular ceramic tile structures, which are rollable, can be fitted and handled easily and exhibit good scratch resistance, washability, chemical resistance and long-term stability. A process for the production of such tile structures is further to be provided.

The object is achieved according to the invention by a tile structure according to claim 1, wherein a carrier layer and a surface layer are bonded together and the surface layer comprises a cured organic polysilazane network, the tile structure as a whole being in rollable form.

Preferred embodiments of the invention are to be found in the accompanying claims as well as the following description and the figures.

It has been found, surprisingly, that, by using a cured organic polysilazane network as the surface coating of the tile structure, it is possible to produce tiles which are so thin that they can be rolled up without the known tile properties being lost. By using organic polysilazanes it has also been possible, surprisingly, to develop and apply a rollable glaze which meets the highest demands in terms of hygiene, cleanability, scratch resistance and chemical resistance of the tile surface and which has high long-term stability. Accordingly, the tile structure according to the invention as a whole is flexible and rollable.

In the figures:

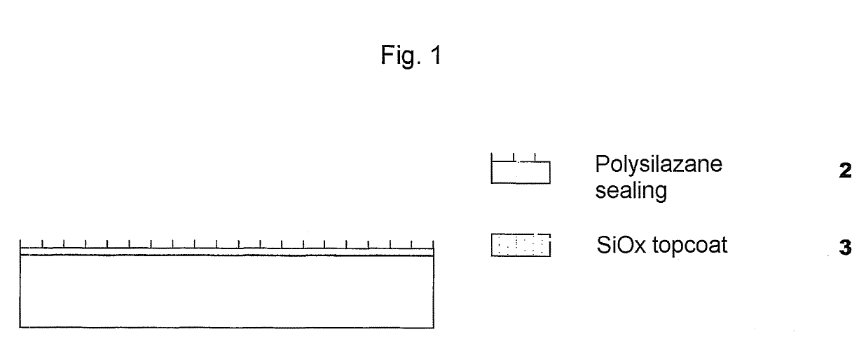

FIG. 1 shows a cross-section through a rollable tile structure bonded to the substrate according to a preferred embodiment of the present invention which, from the outer surface inwards to the substrate, has the following structure:
surface layer (2) of cured organic polysilazanes
first carrier layer (1)

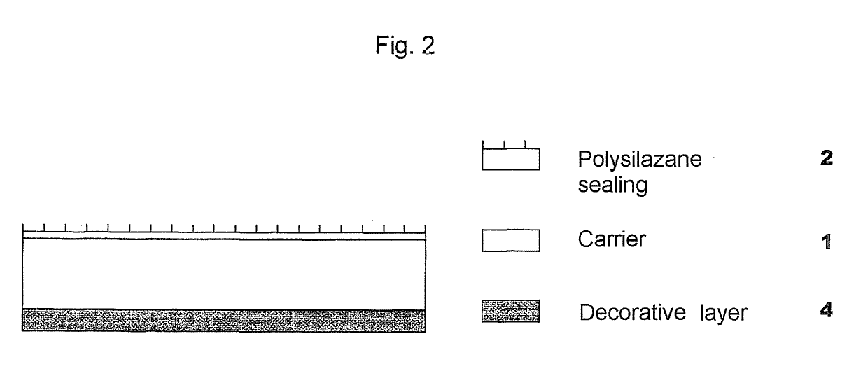

FIG. 2 shows a cross-section through a rollable tile structure bonded to the substrate according to a preferred embodiment of the present invention which, from the outer surface inwards to the substrate, has the following structure:
surface layer (2) of cured organic polysilazanes
first carrier layer (1)
decorative layer (4)

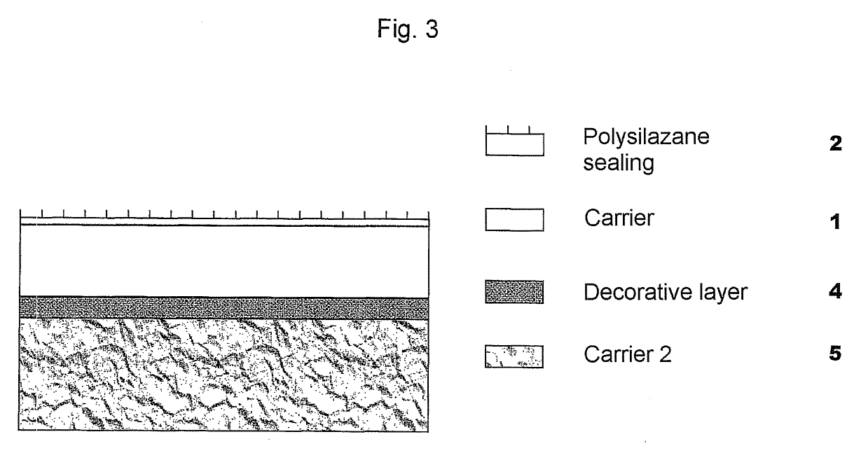

FIG. 3 shows a cross-section through a rollable tile structure bonded to the substrate according to a preferred embodiment of the present invention which, from the outer surface inwards to the substrate, has the following structure:
surface layer (2) of cured organic polysilazanes
first carrier layer (1)
decorative layer (4)
second carrier layer (5)

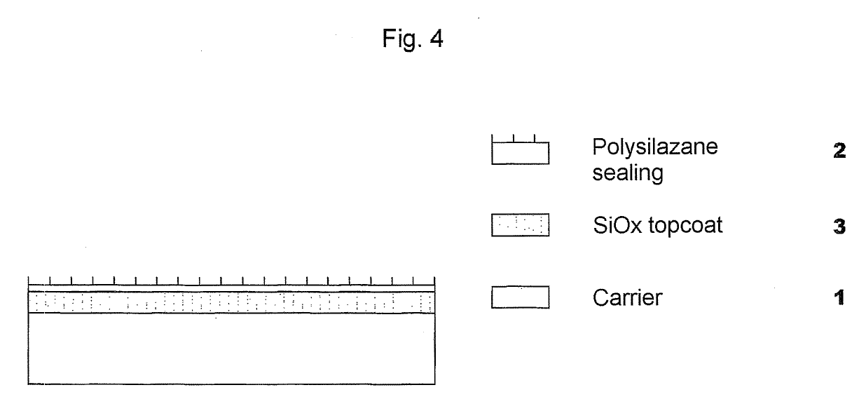

FIG. 4 shows a cross-section through a rollable tile structure bonded to the substrate according to a preferred embodiment of the present invention which, from the outer surface inwards to the substrate, has the following structure:
surface layer (2) of cured organic polysilazanes
nano-ceramic layer (3)
first carrier layer (1)

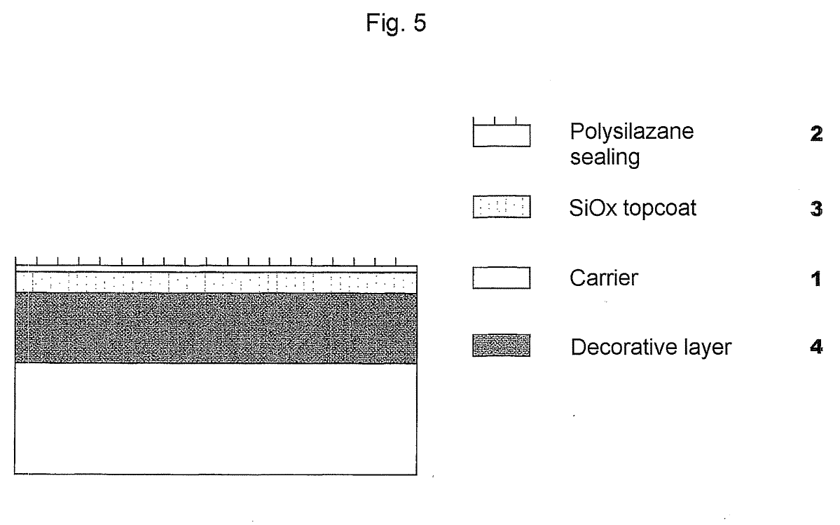

FIG. 5 shows a cross-section through a rollable tile structure bonded to the substrate according to a preferred embodiment of the present invention which, from the outer surface inwards to the substrate, has the following structure:
surface layer (2) of cured organic polysilazanes
nano-ceramic layer (3)
decorative layer (4)
first carrier layer (1)

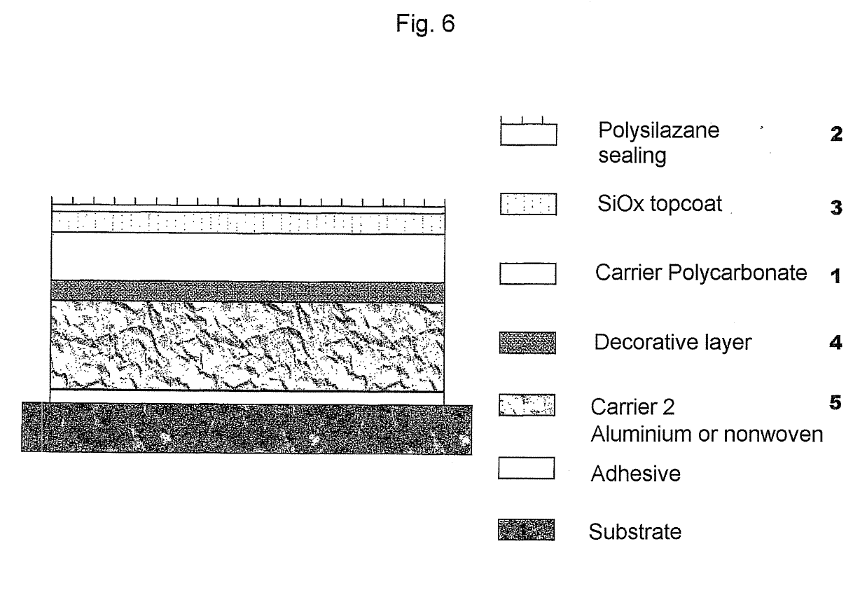

FIG. 6 shows a cross-section through a rollable tile structure bonded to the substrate according to a preferred embodiment of the present invention which, from the outer surface inwards to the substrate, has the following structure:
surface layer (2) of cured organic polysilazanes (sealing)
SiOx layer, referred to as “topcoat”, which corresponds to the nano-ceramic layer (3)
first carrier layer of polycarbonate (carrier layer (1))
decorative layer (4)
second carrier layer of aluminium or a nonwoven (carrier layer (5))
adhesive for bonding to the substrate
substrate

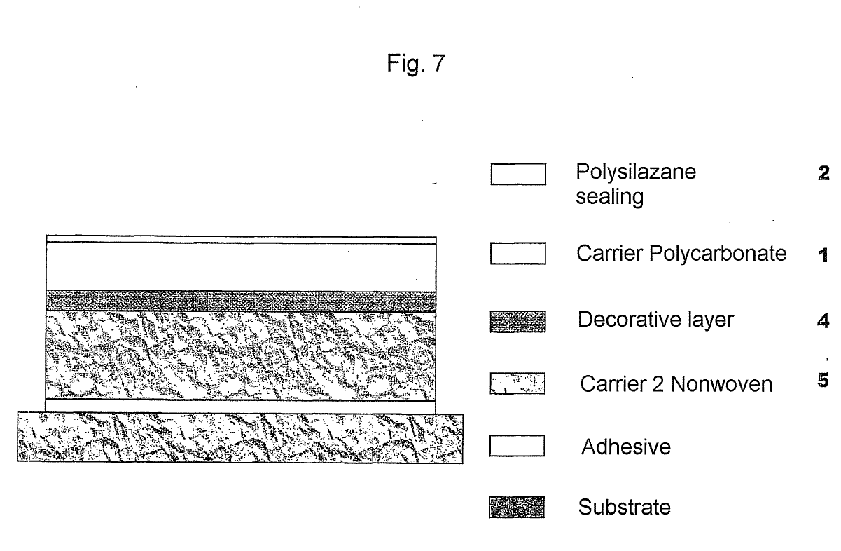

FIG. 7 shows a cross-section through a rollable tile structure bonded to the substrate according to a further preferred embodiment of the present invention which, from the outer surface inwards to the substrate, has the following structure:
surface layer (2) of cured organic polysilazane (sealing)
first carrier layer of polycarbonate (carrier layer (1))
decorative layer (4)
second carrier layer of nonwoven (carrier layer (5))
adhesive for bonding to the substrate
substrate

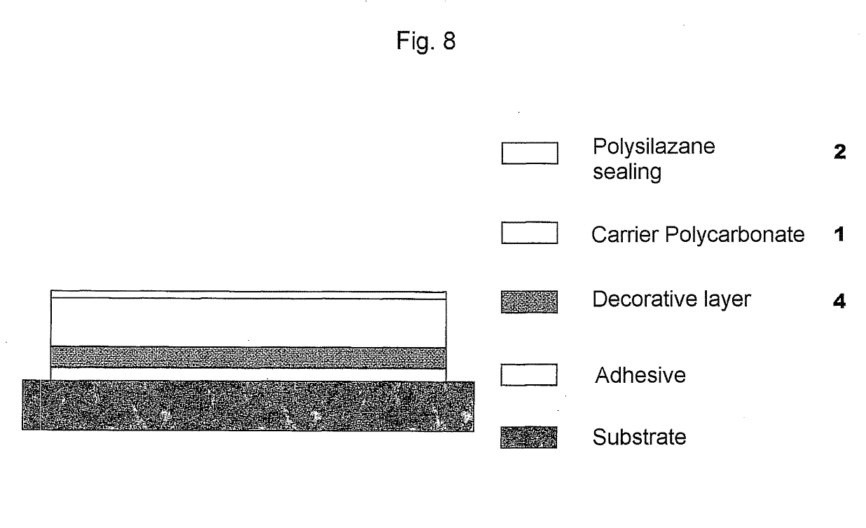

FIG. 8 shows a cross-section through a rollable tile structure bonded to the substrate according to a further preferred embodiment of the present invention which, from the outer surface inwards to the substrate, has the following structure:
surface layer (2) of organic polysilazane
carrier layer (1) of polycarbonate
decorative layer (3)
adhesive as bonding to the substrate
substrate

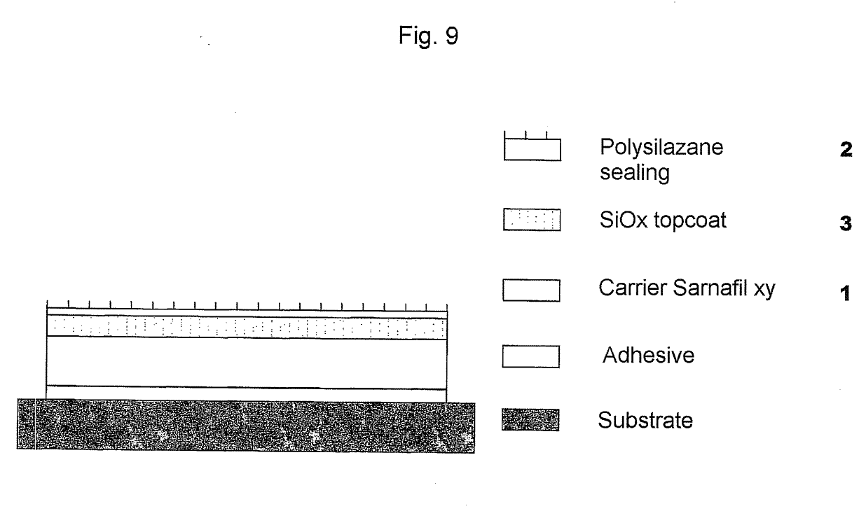

FIG. 9 shows a cross-section through a rollable tile structure bonded to the substrate according to a further preferred embodiment of the present invention which, from the outer surface inwards to the substrate, has the following structure and possesses sound-insulating properties:
surface layer (2) with organic polysilazane network
nano-ceramic layer (3) of SiOx
carrier layer (1) of flexible polyolefin (Sarnafil®)

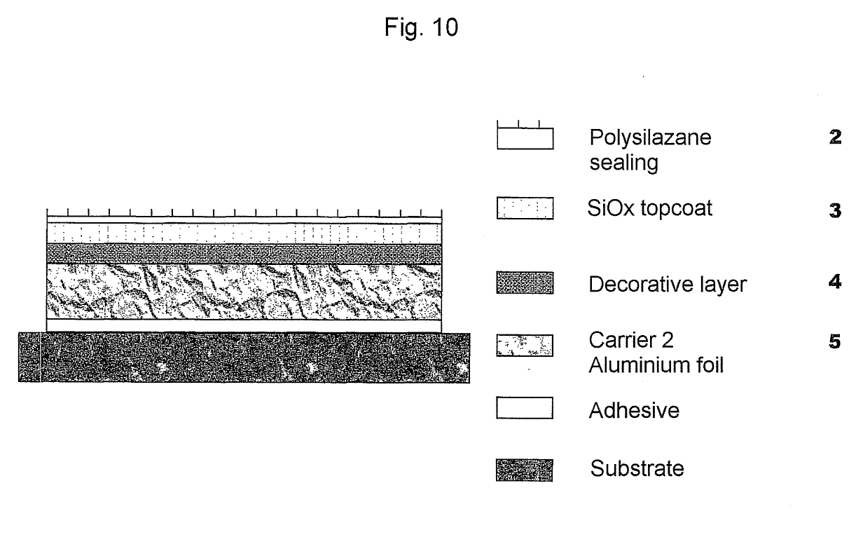

FIG. 10 shows a cross-section through a rollable tile structure bonded to the substrate according to a further preferred embodiment of the present invention which, from the outer surface inwards to the substrate, has the following structure and possesses a metallic appearance:
surface coating layer (2) with a polysilazane network
nano-ceramic layer (3) of SiOx
decorative layer (4)
carrier layer (1) of aluminium
adhesive for bonding to the substrate
substrate

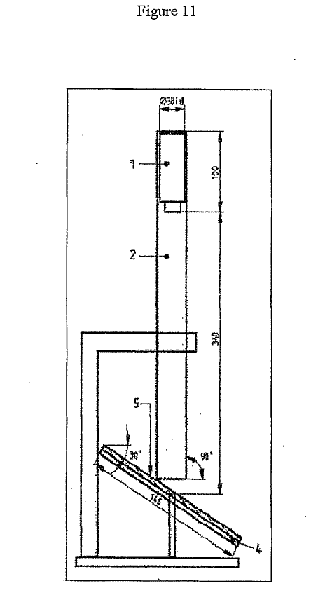

FIG. 11 device for the impact resistance test

The invention is explained in greater detail below with reference to the figures. Identical reference numerals in the figures describe layers which are identical or have identical functions, unless indicated to the contrary.

The present invention accordingly provides a rollable tile structure, that is to say a composite tile material, wherein the structure of the composite tile material is multi-layered.

In a first embodiment of the invention, a rollable tile structure is provided which is the basis for all further tile structures according to the invention. The tile structure according to the first preferred embodiment according to FIG. 1 comprises a carrier layer 1 and a surface layer 2. Both the carrier layer 1 and the surface layer (2) are flexible and thus rollable, and even by bonding the two layers a flexible and rollable structure is obtained. In the present invention, the expression “flexible and rollable” means that the tile structure is not rigid but is flexible in both the longitudinal and transverse directions and is in such a form that it can be rolled up on a roller or drum. It is thereby possible to provide the tile structure according to the invention in a user-friendly rolled-up form. In the present application, the terms “rollable” and “windable” are used as synonyms and therefore mutually interchangeably.

The radii for the delivery of the windable, that is to say rollable, tiles according to the invention are from 5 to 50 cm, in particular from 10 to 30 cm, particularly preferably from 15 to 25 cm. On laying, very small radii of at least 2 cm, in particular 3 cm, particularly preferably 5 cm, are possible. The individual layers of the composite tile material are preferably more flexible and can be rolled with a smaller radius than the composite as a whole which forms the rollable tile. The tile structure according to the invention as a whole is also referred to as “windable or rollable tile”. It is accordingly possible, with the tile structure according to the invention, to offer a tile which has a low weight and is easier and quicker to work with. Instead of applying relatively heavy, rigid ceramic tiles of small surface area, the rollable tile structure according to the invention has a markedly lower weight than the ceramic tiles of the prior all and, because it can be rolled, on the one hand, and because of the markedly greater widths and lengths, on the other hand, which are made possible by the low weight and the ability to be rolled, can be applied to the substrate substantially more easily, quickly and thus less expensively.

The carrier layer 1 is a windable, that is to say rollable, material which can consist of a polymer, a ceramic, a metal, of glass or of cellulose or of composites of those materials or of composites comprising those materials together with other materials, or which contains such materials. It is important that the carrier layer is flexible and rollable and that a surface layer 2 can be applied to the carrier layer. The surface layer 2 can either be applied directly to the carrier layer 1 or bonded to the carrier layer via intermediate layers.

If the carrier layer 1 consists of a metal or contains a metal-containing material, the metals used are preferably aluminium, such as aluminium foil or thin aluminium strips, copper, chromium, nickel, zinc, titanium, vanadium, magnesium, iron and/or steel. It is also possible to use chemical compounds and alloys of or with those metals, as well as combinations of those metals. Particular preference is given to the use of carrier layers of aluminium, in order to obtain a metallic appearance of the surface. The thickness of the metallic layer is, for example, approximately from 20 to 500 μm, preferably approximately from 100 to 150 μm.

The carrier layer 1 can also consist of a polymer material. Any flexible and rollable polymer materials or composites comprising polymer materials can be used. Carrier materials of polycarbonate, polymethyl methacrylate, polyether ketone, polyamide, polyethylene terephthalate, polyvinyl chloride, polyolefins, polyethylene, polypropylene, oriented polypropylene, polyester and polystyrene are particularly preferred. In the case of polyolefins, materials comprising or consisting of flexible polyolefins are used in particular. Such materials are also known as thermoplastic polyolefin or flexible polyolefin alloy. Such flexible polyolefins are based on polyethylene and polypropylene materials. Such materials are supplied commercially, for example by Sika, Switzerland, for example with the brand names Sikaplan® and Sarnafil®. Advantages of such materials are their high flexibility and their sealing properties with respect to liquids and gases, their high chemical resistance, their durability as well as their thermal and mechanical load capacity.

Particular preference is given further to the use of polycarbonates as polymeric carrier layer materials. Polycarbonates are polymers from the polyester family, which belong to the prior art and are supplied under various trade names. Such polycarbonate carrier materials are supplied in the form of polycarbonate foils, for example, by Bayer MaterialScience with the brand names Makrofol®. Bayfol® or Marnoth®. Of course, other polycarbonate foils known per se consisting of different polycarbonate materials and mixtures thereof can also be used. In an embodiment of the invention, such polycarbonates that are highly transparent are used. It is, however, possible to use coloured polycarbonates or matt or semi-transparent polycarbonates. These possible variations constitute an advantage of the tile structure according to the invention which should not be underestimated.

The carrier material can optionally be provided on the back and strengthened with a nonwoven 5, as is shown, for example, in FIGS. 6 and 7, which levels out uneven areas in the substrate to which the tile structure is applied and permits easier application of the adhesive and better adhesion to the substrate. One or more further layers, for example a decorative layer 4, can be arranged between the carrier layers 1 and 5. Nonwoven materials are flat textile structures of individual fibres. Woven fabrics and foils can also be used as an alternative to nonwoven materials. Nonwoven materials are any nonwovens known per se, that is to say, for example, also those of animal or plant origin. Particular preference is given, however, to fibre materials of chemical fibres, such as polypropylene, polyethylene, polyvinyl chloride, polyesters such as polyethylene terephthalate. Examples of mineral fibre materials are those of glass, of mineral wool and basalt. Particular preference is given to the use of nonwovens which have sound-insulating and/or heat-insulating properties, which consist of fire-retardant materials or contain fire-retardant additives and which ensure a good bond with the substrate. Bonding of the nonwoven materials to the carrier materials can be carried out by methods known per se such as, for example, dry or wet lamination or by pressing with or without adhesive.

The thickness of the carrier material is in principle not important. A carrier material is preferably chosen which has a thickness such that the carrier material has sufficiently high rigidity while at the same time being flexible and rollable. What is crucial is that the thickness is such that the tile structure provided according to the invention, in particular the ceramic tile structure, likewise remains rollable. The carrier layers formed of the carrier materials preferably each have a thickness in the range from 100 to 200 μm, for example from 120 to 170 μm; the total thickness of the tile structure is in a range from 300 to 1000 μm, preferably from 400 to 600 μm or from 300 to 500 μm.

According to the invention, the tile structure can contain various carrier layers, which can consist of the same or of different materials. Depending on application, a carrier layer 1 of polycarbonate, for example, can be combined with a carrier layer 5 of aluminium, which layers are bonded together either directly or via an intermediate layer 3, which can be a nano-ceramic layer. However, the tile structure can also contain a third carrier layer, the number of layers being limited by the requirement that the tile structure as a whole is to be rollable. The radii to be observed to that end were described above. The carrier layer facing inwards towards the substrate can preferably be provided on the back with a nonwoven material, as mentioned above, which then forms the second or third carrier layer.

A decorative or design layer 4 can be applied to the upper side of the carrier material. If the carrier material is transparent or semi-transparent, such as a carrier material of polycarbonate, the decorative layer can also be applied to the lower side of the carrier material. Application of the decorative layer to the carrier material can be carried out by processes known per se. Examples thereof are printing processes such as flexographic printing or digital printing. In the case of a transparent carrier material, the decorative layer can optionally also be part of the nonwoven provided on the back for strengthening the carrier material or, if a nonwoven is not used, the carrier material can be provided on the back with the decorative layer. The decorative layer can be produced as an individual layer and bonded to the carrier material or carrier materials by conventional termination processes, for example by means of adhesives or by adhesive forces. Alternatively, the carrier material can be printed with the decorative layer.

The carrier materials can also be bonded directly to one another, that is to say the first carrier layer to the second carrier layer, or the second carrier layer to the third carrier layer. An example thereof is the bonding of an aluminium carrier as the second carrier layer to a nonwoven material as the third carrier layer. The person skilled in the art can combine the carrier materials with one another according to the desired material property and according to the application in order to obtain, with this variety of possible variations, the desired properties of the end product.

The tile structures according to the invention are characterised by the material properties given by the sum of the properties of the carrier layers used and the surface coating.

A particular difficulty when finding the problem solutions for the present invention was that of providing a tile structure which possesses the performance characteristics known per se of ceramic tiles and additionally fulfils the criteria of flexibility, a markedly lower weight as compared with ceramic tiles, and easier handling ability. The properties of ceramic tiles include a limited water absorbency, in order to render the tiles and the substrate resistant to moisture and also to frost, high wear resistance, resistance to scratching, to the action of chemicals such as acids and lyes, in particular to chemicals such as are used in conventional cleaning agents, good cleanability, in order to meet hygiene requirements, resistance to scratching, and long-term stability.

Surprisingly, it has been found that, by applying an organic polysilazane layer to the surface of the composite material, it is possible to obtain a tile structure which satisfies the above-mentioned criteria, including windability, or rollability, and flexibility.

Polysilazanes are known per se. They are polymers of the following general structural formula (1), the polymer chains of which are composed alternately of silicon and nitrogen atoms.

—(SiR′R″—NR′″)n- (1)

wherein R′, R″, R′″ independently of one another represent hydrogen or an optionally substituted alkyl, aryl, vinyl or (trialkoxysilyl)alkyl radical, with the proviso that all the radicals R′. R″ and R′″ do not simultaneously represent hydrogen, wherein n is an integer and n is such that the polysilazane has a number-average molecular weight of from 150 to 150,000 g/mol.

The organic polysilazanes which can be used according to the invention for coating the rollable composite carrier material preferably comprise a solution of an organic polysilazane or a mixture of organic polysilazanes of the general formula (2)

—(SiR′R″—NR′″)n-(SiR*R**—NR***)p- (2)

wherein
R′, R′″ and R*** represent hydrogen and R″, R* and R** represent methyl;
R′, R′″ and R*** represent hydrogen and R″, R* represent methyl and R** represents vinyl;
R′, R′″, R* and R*** represent hydrogen and R″ and R** represent methyl;
   n and p are such that the organic polysilazane has a number-average molecular weight of from 150 to 150,000 g/mol.

Preference is given to the use of polysilazanes of formula (3)

—(SiR′R″—NR′″)n-(SiR*R**—NR***)p-(SiR1R2-NR3)q- (3)

wherein
R′, R′″ and R*** represent hydrogen and R″, R*, R** and R2 represent methyl, R3 represents (triethoxysilyl)propyl and R1 represents methyl or hydrogen;
n, p and q are such that the polysilazane has a number-average molecular weight of from 150 to 150,000 g/mol.

In general, the amount of polysilazane in the solvent is from 1 to 80 wt. % polysilazane, preferably from 5 to 50 wt. %, particularly preferably from 10 to 40 wt. %.

On account of the organic content in the polysilazane structure and the reduced Si—H content in the binder, flexible structures are obtained. These systems are suitable in particular for coating the rollable carrier materials (1) or flexible nano-ceramic layers (2), because they have a higher coefficient of thermal expansion.

Suitable solvents for the polysilazane formulation are in particular organic solvents which do not contain water and do not contain reactive groups (such as hydroxyl or amine groups). Such solvents are, for example, aliphatic or aromatic hydrocarbons, halogenated hydrocarbons, esters such as ethyl acetate or butyl acetate, ketones such as acetone or methyl ethyl ketone, ethers such as tetrahydrofuran or dibutyl ether, as well as mono- and polyalkylene glycol dialkyl ethers (glymes) or mixtures of these solvents.

The polysilazane formulation can contain, as an additional constituent, further binders such as are conventionally used in the production of surface coatings. Such binders can be, for example, cellulose ethers and esters, such as ethyl cellulose, nitrocellulose, cellulose acetate or cellulose acetobutyrate, natural resins such as rubber or colophonium resins, or synthetic resins, such as polymerisation resins or condensation resins, for example aminoplasts, in particular urea and melamine-formaldehyde resins, alkyd resins, acrylic resins, polyesters or modified polyesters, epoxides, polyisocyanates and blocked polyisocyanates, or polysiloxanes.

Further constituents of the polysilazane formulation can be additives which, for example, influence the viscosity of the formulation, substrate wetting, film formation, lubricating action or, the aeration behaviour, which additives are described in greater detail below.

An additional constituent of the polysilazane formulation can be catalysts such as, for example, organic amines, acids as well as metals or metal salts or mixtures of these compounds.

Catalysts are preferably used in amounts of from 0.001 to 10%, in particular from 0.01 to 6%, particularly preferably from 0.1 to 3%, based on the weight of the polysilazane.

Examples of amine catalysts are ammonia, methylamine, dimethylamine, trimethylamine, ethylamine, diethylamine, triethylamine, n-propylamine, isopropylamine, di-n-propylamine, diisopropylamine, tri-n-propylamine, n-butylamine, isobutylamine, di-n-butylamine, diisobutylamine, tri-n-butylamine, n-pentylamine, di-n-pentylamine, tri-n-pentylamine, dicyclohexylamine, aniline, 2,4-dimethylpyridine, 4,4-trimethylenebis-(1-methylpiperidine), 1,4-diazabicyclo[2.2.2]octane, N,N-dimethylpiperazine, cis-2,6-dimethylpiperazine, trans-2,5-dimethylpiperazine, 4,4-methylenebis(cyclohexylamine), stearylamine, 1,3-di-(4-piperidyl)-propane, N,N-dimethylpropanolamine, N,N-dimethylhexanolamine, N,N-dimethyloctanol-amine, N,N-diethylethanolamine, 1-piperidineethanol, 4-piperidinol.

Examples of organic acids are acetic acid, propionic acid, butyric acid, valeric acid, caproic acid.

Examples of metals and metal compounds as catalysts are palladium, palladium acetate, palladium acetylacetonate, palladium propionate, nickel, nickel acetylacetonate, silver powder, silver acetylacetonate, platinum, platinum acetylacetonate, ruthenium, ruthenium acetylacetonate, ruthenium carbonyls, gold, copper, copper acetylacetonate, aluminium acetylacetonate, aluminium tris(ethylacetoacetate).

Depending on the catalyst system used, the presence of moisture or of oxygen can play a role in the curing of the coating. Accordingly, by choosing a suitable catalyst system, rapid curing can be achieved at high or low humidity or at a high or low oxygen content. The person skilled in the art is familiar with these influences and will adjust the atmospheric conditions accordingly by suitable optimisation methods.

The polysilazane formulations used according to the invention can be applied to all the rollable carrier materials and flexible nano-ceramic layers used in the present invention. The polysilazane coating can be applied directly both to the rollable carrier material and to the flexible nano-ceramic layer. On account of the smoothing properties and the advantageous surface polarity, a high-gloss, easy-to-clean surface is achieved in each case.

Coating with the polysilazane formulation can be carried out by processes such as are conventionally used in coating. Such processes can be, for example, spraying, dipping or flooding. Thermal after-treatment can then be carried out in order to accelerate curing of the coating. Depending on the polysilazane formulation and the catalyst used, curing already takes place at room temperature but can be accelerated by heating. Accordingly, it is possible to cure the polysilazane layer at about 120° C. in the course of about 120 minutes, so that a polysilazane glaze is obtained.

In addition, after application of the coating, the gloss level increases as compared with the uncoated material.

It is accordingly possible to produce a protective layer which has a markedly smaller thickness than conventional glazes, combined with lower material consumption and lower solvent emissions, and which additionally has superior properties to conventional glazes. Accordingly, the polysilazane coating has considerable economic and ecological advantages.

On account of the high reactivity of the polysilazane, curing of the coating takes place at room temperature or below, but can be accelerated by increasing the temperature. Preferably, the coating is cured at a temperature in the range from 10 to 120° C., preferably from 80 to 100° C. The maximum possible temperature for curing depends on the rollable carrier material 1 to which the coating is applied. In the case of metals, such as, for example, aluminium, it can be a relatively high temperature of from 180 to 200° C. or higher. If the coating is applied to a polymer as the rollable carrier material, it is recommended to work at a lower temperature so that softening of the polymer does not occur, preferably at from 25 to 120° C., particularly preferably at from 80 to 100° C. If the rollable carrier material permits working at from 160 to 170° C., curing takes place within 15 to 30 minutes.

Humidity also has an effect on the curing of the coating. At relatively high humidity, more rapid curing takes place, which can be an advantage; by contrast, curing in an atmosphere containing only a little atmospheric moisture, for example in a drying cabinet, results in a slow and uniform curing process. Curing of the coating according to the invention can therefore take place at a relative humidity of from 0 to 100%.

The flexible polysilazane coating 2 has a thickness of at least 1 μm, preferably from 2 to 20 μM, particularly preferably from 3 to 10 μm, and ensures outstanding protection of the surfaces against corrosion and scratching. In rollable carrier materials coated in that manner, pitting by impurities is prevented because it is a topcoat having high temperature resistance. Cleaning is facilitated considerably by the smooth surface.

Where reference is made in the present description to “novel ceramic tiles”, these are the tile structures according to the invention in which at least one layer contains ceramic materials or consists of ceramic materials. For example, the use of a nano-ceramic layer, preferably of SiOₓ, imparts additional ceramic properties to the tile structure according to the invention. While the tile structure in the invention as a whole thereby acquires properties which are comparable to those of a ceramic tile, for example in respect of hardness, long-term stability, acid resistance, etc., the flexibility and thus the rollability of the tile structure is retained at the same time. The expression “ceramic tile structure” is attributable in particular to the fact that the organic polysilazane coating of the surface layer cures, and this exhibits all the surface properties possessed by a ceramic tile according to the prior art but at the same time does not adversely affect the rollability of the tile structure as a whole. After curing of the organic polysilazanes, a polysiloxane structure having a more highly crosslinked polysilazane structure is obtained. The proportion of more highly crosslinked polysilazane structure increases towards the substrate.

In the simplest embodiment according to claim 1 and FIG. 1, the rollable tile structure provided according to the invention consists of a carrier layer 1 having a surface layer 2 comprising a cured organic polysilazane network. The properties of the tile structure according to the invention can be changed and adapted to the requirements of the customer and of the substrate by means of further layers. A large number of embodiments is possible, and some particularly preferred tile structures are described in greater detail below. FIG. 3 shows such a structure having an additional decorative layer.

In one embodiment of the invention, a nano-ceramic layer 3 is arranged between the carrier layer 1 and the surface layer 2, that is to say the polysilazane sealing layer is located on the nano-ceramic layer 3, which in turn is bonded to the carrier layer 1. An example thereof is FIG. 3.

The nano-ceramic layer 3, which must of course be flexible in order to impart flexibility and rollability to the structure as a whole, is particularly preferably silicon oxide (SiOx) coatings, which have high transparency to light with outstanding barrier properties towards gases and odorous substances. The flexible nano-ceramic layer 3 increases the resistance of the tile structure against the penetration of water molecules, improves the flex-crack resistance and permits a high degree of adhesion both of the polysilazane coating and of the underlying rollable carrier materials. The nano-ceramic layer 3 is suitable, owing to its transparency, for making underlying decorative layers visible to the observer. Such nano-ceramic layers having barrier properties are available commercially from Alcan Packaging under the trademark CERAMIS®.

The SiOx layers which are particularly preferably used as the nano-ceramic layer 3 are applied to the carrier material by processes known per se, for example by electron beam vapour deposition of SiO₂ in vacuo. In addition to such a vacuum vapour deposition, a plasma polymerisation is also possible. Functional components, for example colouring pigments such as TiO₂, can in turn be introduced into the nano-ceramic layer 3 in an amount that brings about effective colouring. As with the carrier material 1, the nano-ceramic layer 3 can also be printed in a single colour or multi-coloured, for example by flexographic printing or digital printing processes, . . . please note that only SiOx layers are disclosed as the nano-ceramic layer. If you are aware of any other nano-ceramic layers, these are to be inserted.

The layer thickness of the flexible nano-ceramic layer is preferably at least 1 μm, in particular from 3 to 15 μm, particularly preferably from 5 to 10 μm. Of course, other barrier layers, such as barrier layers of aluminium or aluminium oxide, can also be used either instead of or in combination with SiOₓ layers.

When SiOx nano-ceramic layers are used, polycarbonate or a flexible polyolefin material is preferably used as the carrier material. Flexible polyolefin materials are obtainable, for example, from SIKA under the name Sarnafil®. Polycarbonate carrier materials are preferred layer materials owing to their good optical and mechanical properties. The carrier layers referred to here as “polycarbonate” can consist of polycarbonates, of polycarbonate blends and mixtures of polycarbonates with other polymers. Such polycarbonate carrier materials are supplied in the form of polycarbonate foils, for example, by Bayer MaterialScience with the brand names Makrofol®. Bayfol® or Marnoth®. Of course, other polycarbonate foils known per se of different polycarbonate materials and mixtures thereof can also be used. Preference is given to the use of polycarbonates that are highly transparent.

In further embodiments of the invention, one or more further carrier materials can be used in order further to improve the properties of the windable or rollable ceramic tiles according to the invention. These include aluminium carriers or carriers of nonwoven materials (see FIGS. 6, 7 and 10) or other materials. According to the customer's wishes and according to the demands made of the tile material, the desired material properties can be provided by the various possible layer combinations. However, it is always a requirement that a surface layer of an organic polysilazane network is used in conjunction at least with a flexible carrier layer.

In a further embodiment of the invention, a first carrier layer 1 of polycarbonate is coated with a surface layer 2 of an organic polysilazane. A nano-ceramic layer 3 in the form of an SiOₓ layer is provided on the side of the first carrier layer 1 that is remote from the surface layer 2. Because of the transparency both of the polycarbonate carrier material and of the nano-ceramic layer 3, a decorative layer 4 is applied to the side of the nano-ceramic layer 3 that is remote from the poiycarbonate carrier material. The decorative layer can optionally be provided on the back with a further carrier material of aluminium or alternatively with nonwoven material. As a further alternative, the aluminium carrier material can be provided on the back with a nonwoven material. An example thereof is shown in FIG. 1.

Decorative three-dimensional effects can also be achieved by texturing the tile structure or parts of the tile structure, such as individual carrier layers or combinations of carrier layers, for example a combination of the nano-ceramic layer 3 and the carrier layer 1 or a combination of the carrier layer 1 and the carrier layer 5, optionally with a nano-ceramic layer 3, by embossed printing prior to the application of the polysilazane coating. Following the texturing, the polysilazane surface coating is applied.

The production of the individual layers and the combination of the individual layers to form the rollable composite tile structure is carried out by processes known per se. For example, the rollable carrier material 1, for example of polycarbonate, is combined with the flexible nano-ceramic layer 3 on the front side in a high-vacuum installation. A decorative layer 4 with design elements can be applied either to the rear side of the carrier in the case of a transparent or semi-transparent rollable carrier material or to the front side in the case of non-transparent rollable carrier materials, for example by digital printing processes, anodisation, screen printing, contra printing or painting. The flexible polysilazane coating is then applied by a roll-to-roll process and cured. A roll-to-roll process is to be understood as a process in which the carrier material is unrolled from a roll, one or more layers are applied in a continuous process, and the resulting intermediate or end product is wound onto a further roll. In this production process, the end product is already in the form of a roll during the production process.

The carrier material 1 can be bonded to further carrier materials, for example an aluminium carrier material 5. Greater stability and higher barrier properties are thereby obtained.

A nonwoven material can further be applied to the underside of the rollable tile according to the invention in order to improve ease of laying, so that it can successfully be laid even on poor quality substrates and uneven areas in the substrate can be levelled out. The thickness of the nonwoven layer is approximately from 100 to 1000 μm, preferably approximately from 300 to 500 μm.

No particular requirements are made of the substrate. The windable or rollable tile according to the invention adapts to the substrate, in particular when a nonwoven is provided on the underside.

Adhesive bonding of the tiles according to the invention, that is to say of the rollable tile structure, is carried out using commercial adhesives known per se, insofar as they are compatible with the tile materials.

A further advantage of the rollable tiles according to the invention is that they are easy to handle and lay. On the one hand, the materials used are such that the tile structure has a low weight as compared with conventional ceramic tiles, which makes it easier to apply to walls, for example. Because the rollable tile structure according to the invention can be laid end-to-end, joints and accordingly the jointing conventionally necessary in the case of ceramic tiles become superfluous. In an embodiment of the invention, any gaps that remain between two tile strips are joined, that is to say bonded together and sealed with respect to the substrate, using the organic polysilazanes used according to the invention or other polysilazane materials.

Bonding of the individual layers is carried out in a manner known per se. For example, bonding of the aluminium carrier to a nonwoven is carried out by thermolamination at about 130° C.; application of the SiOx layer is carried out in vacuo; application of the polysilazane layer is carried out by spraying or dipping.

In summary, the rollable or windable tile structure provided according to the invention, in particular a tile structure having carrier layers with ceramic layers, has the following properties:
windable or rollable
water-tight
impermeable to vapour
resistant to impact
resistant to flexing
washable
resistant to scrubbing
   fireproof
free of internal stresses
can be rendered hydrophobic or hydrophilic
easy to clean
repels dirt
acid- and lye-resistant
can be rendered antibacterial
can be rendered self-cleaning
free of PVC, VOC and formaldehyde
free of heavy metals, stabilisers, plasticisers
completely environmentally compatible
can be laid virtually without joints
without nano risks
can be applied to different substrates
can be provided with different designs

The invention is described below by means of exemplary embodiments. The following tests were used to determine and compare the product properties. Scratch resistance: determined according to EN 259-1. The test specimen was scrubbed 300 times, starting with a gentle abrasive. Increasingly harder agents were then used until the test specimen exhibited a visible change to the surface. Soft, medium and hard Scotch-Brite® sponges, soft and hard brushes, steel wool and abrasive paper of grade P240 are preferably used. The tile structures according to the invention are highly scratch-resistant and resistant to scrubbing according to EN 259-1.

Acid and staining neutrality: determined according to EN 423. Pipettes, cotton wool pads, chemical substances, microfibre cloths, brushes and abrasives were preferably used for cleaning. From 1 ml to 2 ml of the chemical substance were applied to the test specimen. If the substance ran off, a cotton wool pad was applied. The main duration of action was 2 hours. Prior to each cleaning operation, the still wet stains were dabbed with cotton, working from the edge to the middle of the stain. After cleaning, the remaining stains were viewed from all directions from a distance of approximately 800 mm at an angle of observation of about 45° and while slowly rotating the viewing table. If a stain was visible, it was scrubbed with a gentle abrasive or a cleaning agent and studied again. The tile structures according to the invention are acid-neutral and stain-neutral according to EN 423. Impact resistance: determined according to EN 259-2. Preferably 1 joule of energy was applied to the test specimen at an angle of 30 degrees, the impact element having a diameter of 20 mm and a curvature of 2 mm. The test piece was studied with the naked eye one hour after being subjected to the falling load. A check was made as to whether the top layer was intact or exhibited irreversible damage; this is generally indicated by breaking or tearing of the surface layer, which can extend as far as the substrate of the wallcovering. The tile structures according to the invention are impact resistant according to EN 259-2.

### Exemplary Embodiment I

A carrier layer of polycarbonate having a layer thickness of about 150 μm from Bayer, supplied by Colorprint Techfilms under the product name Markopol®, is coated on the front side with silicon oxide in order to obtain a nano-ceramic layer. Electron beam vapour deposition is used for that purpose, in order to achieve controlled and uniform vapour deposition of the coating material as well as high transparency. The layer thickness is about 8 μm.

In a subsequent step, the side of the carrier layer that is remote from the silicon oxide layer is printed by means of a digital printing process. The devices required for this are supplied, for example, by Müller Martini Druckmaschinen GmbH, Maulburg.

In a subsequent step, the side printed with the decoration is laminated with a nonwoven material.

As a final layer, a layer of organic polysilazanes is applied to the outer side of the polycarbonate layer. To that end, a 40% solution of the organic polysilazane described by formula (3) in n-butyl acetate is used, to which appropriate additives have been added. After application of the layer, curing takes place within a period of one hour at 120° C.

The composite tile material produced in this way can be fixed to the substrate, in particular to walls or floors, by means of adhesives known per se. For example, adhesives from SIKA, Switzerland, are used. SIKA adhesives, and of course also adhesives and sealing materials from other companies, can also be used for sealing ends and joints.

The following test devices were used: pipettes, cotton wool pads, chemical substances, microfibre cloths, brushes and abrasives.

In order to carry out the test, from 1 ml to 2 ml of the chemical substance were applied to the test specimens. If the test substance ran off, a cotton wool pad was applied. The main duration of action was 2 hours.

Prior to each cleaning operation, the still wet stains are dabbed with cotton, working from the edge to the middle of the stain.

After cleaning, the remaining stains are viewed from all directions from a distance of approximately 800 mm at an angle of observation of about 45° and while slowly rotating the viewing table. If a stain was visible, it was scrubbed with a gentle abrasive or a commercially available cleaning agent and studied again.

The following test specimens were used: Vaporex vapour barrier for wet rooms, Erfurt woodchip wallpaper, Kertala, conventional tile.

Testing was carried out using the following substances: oil of turpentine, benzine, nail varnish remover, miracle agent (Rädibuz). Suso® bathroom cleaner, Durgol® decalcifier, Cilit® Bang Grime and Lime, Toilet Duck®, blackcurrant juice, sunflower oil, red wine, bleach, soft soap, coffee, denatured ethanol, hydrogen peroxide and 10% ammonia solution.

The following scale was used as the index for classifying the result after cleaning/scrubbing: 0 no change, 1 very little change, 2 little change, 3 change, 4 pronounced change.

The result is shown in Table 1. The product according to the invention is characterised as Kertala®.

The test report states: All the tested substances can simply be wiped off using a cloth and a little water. Liquids bead up considerably. Drops form; Kertala® does not become wet.”

The test specimen is scrubbed 300 times, beginning with a gentle abrasive. Increasingly harder agents are then used until the test specimen exhibits a visible change to the surface.

The following test specimens were used: Erfurt woodchip wallpaper, Vaporex® vapour barrier, tile, Kertala®.

The following abrasives were used: Scotch Brite® sponge orange (soft), Scotch Brite® sponge blue (medium hard), brush soft, brush hard, Scotch Brite® sponge green (hard), steel wool, P240 abrasive paper.

The following scale was used as the index for classifying the result after cleaning/scrubbing: 0 no change, 1 very little change, 2 little change, 3 change, 4 pronounced change.

The result is shown in Table 2.

Hard sponges such as “Scotchprint® kraftvoll and dauerhaft” [powerful and lasting] are unsuitable for tiles. The same applies to Kertala®. High-gloss tiles and high-gloss Kertala wear more quickly than matt ones. Kertala® has virtually the same scratch resistance as conventional tiles.

As the test device, a test body was allowed to fall onto the sample with one joule of energy at an angle of 30 degrees. The impact element had a diameter of 20 mm and a curvature of 2 mm.

The test piece was studied with the naked eye one hour after being subjected to the falling load. A check was made as to whether the top layer was intact or whether it exhibited irreversible damage. This is generally indicated by breaking or cracking of the surface layer, which can extend as far as the substrate of the wallcovering.

The following test specimens were used: hard KERTALA®, soft KERTALA®, elastic KERTALA®, standard tile, Duravit® mirror tile, Al DO wall paint.

Hard plaster as substrate was found to be too soft; it was necessary to use Eternit in order to achieve meaningful results. In the case of the standard tile, the test resulted in layer fractures. In the case of the Duravot® mirror tile, the glaze was likewise damaged. In the case of Al DO there was plastic deformation and surface damage. In the case of KERTALA®, the surface remained intact in spite of slight plastic deformation. KERTALA® accordingly exceeds the properties of conventional tiles and hitherto known alternative wall coverings, which is evidence of the high measure of the invention.

According to the standard, KERTALA® is impact resistant. The effects of the impact test differed depending on the carrier used: hard KERTALA® resulted in no plastic deformation, consequently damage to the glaze occurred more quickly; soft KERTALA tended to result in plastic deformation, so that the glaze remained intact. Elastic KERTALA, with which no plastic deformation occurred and the surface remained intact, proved to be most successful.

### Exemplary Embodiment II

A 0.030 mm thick carrier foil of non-soft-annealed aluminium is laminated on the back with a nonwoven material by Erfurt obtainable under the brand name Vario Vlies®. The nonwoven is a smooth material which consists of cellulose and textile fibres combined with polymeric binders. The aluminium foil has barrier properties in order to prevent the passage of water molecules.

A ceramic silicon oxide coating is applied to the front side of the aluminium carrier material by means of electron beam vapour deposition.

An organic polysilazane layer as described in Example 1 is applied to the silicon oxide layer obtained in this way.

The tile structure obtained in this way can be bonded to the substrate using adhesives known per se. The same is true of the sealing of ends and joints, for which sealing materials known per se are used.

The tile structures according to the invention can be produced and, like wallpapers, applied to the substrate in roll form. The substrate can be pretreated, in particular to level out uneven areas, for example by application of a high-viscosity levelling agent or by application of a nonwoven material either directly to the substrate or by using a tile structure which has a nonwoven material on the side remote from the polysilazane surface layer. The substrate is pretreated with commercial adhesives which are compatible with the rollable tile structure material, or the adhesive is applied directly to the surface of the tile structure opposite the polysilazane layer. The rollable composite tile materials according to the invention are cut to the length required and placed next to one another strip by strip. The joints that usually form when ceramic tiles are laid are reduced to an absolute minimum, as is conventionally known for wallpapers. The strips of tiles are applied to the substrate end to end and can be bonded together using sealing materials known per se, for example of organic polysilazanes, so that maximum surface sealing is obtained. In that manner, the substrate is completely sealed against penetration of liquids and gases from the outside even at the ends.

The surfaces obtained by application of the composite tile materials according to the invention are easy to clean. Liquid dirt can be removed by simply wiping with a cloth because the liquid is unable to penetrate into the tile structure owing to the polysilazane surface sealing. Solid dirt can likewise be removed simply by wiping with a cloth. More stubborn solid dirt can easily be washed off using conventional domestic, in particular environmentally friendly cleaning agents, for example also detergents. The above test results show the outstanding cleaning properties of the tile composites according to the invention.

TABLE I

| | Before cleaning/scrubbing | | | | After cleaning/scrubbing | | | |
|---|---|---|---|---|---|---|---|---|
| Chemical | Woodchip | | | | Woodchip | | | |
| Substance | wallpaper | Vaporex | Kertala | Tile | wallpaper | Vaporex | Kertala | Tile |
| 1 | 2 | 0 | 1 | 3 | 0 | 0 | 0 | 0 |
| 2 | 0 | 0 | 1 | 1 | 0 | 0 | 0 | 0 |
| 3 | 2 | 0 | 1 | 1 | 2 | 0 | 0 | 0 |
| 4 | 0 | 0 | 3 | 2 | 0 | 0 | 0 | 0 |
| 5 | 3 | 0 | 3 | 3 | 2 | 0 | 0 | 0 |
| 6 | 2 | 0 | 1 | 2 | 1 | 0 | 0 | 0 |
| 7 | 3 | 3 | 1 | 2 | 1 | 2 | 0 | 0 |
| 8 | 4 | 4 | 3 | 3 | 1 | 3 | 0 | 0 |
| 9 | 4 | 4 | 4 | 4 | 3 | 4 | 0 | 0 |
| 10 | 4 | 1 | 4 | 4 | 4 | 0 | 0 | 0 |
| 11 | 4 | 4 | 4 | 4 | 3 | 4 | 0 | 0 |
| 12 | 4 | 0 | 2 | 3 | 0 | 0 | 0 | 0 |
| 13 | 4 | 4 | 3 | 3 | 1 | 4 | 0 | 0 |
| 14 | 4 | 4 | 4 | 4 | 2 | 4 | 0 | 0 |
| 15 | 0 | 0 | 0 | 0 | 0 | 0 | 0 | 0 |
| 16 | 4 | 0 | 4 | 4 | 0 | 0 | 0 | 0 |
| 17 | 4 | 0 | 1 | 1 | 1 | 0 | 0 | 0 |

01 Oil of turpentine
02 Benzine
03 Nail polish remover
04 Miracle agent (Rädibuz)
05 Suso bathroom cleaner
06 Durgol decalcifier
07 Cilit Bang Grime and Lim
08 Toilet Duck
09 Blackcurrant juice
10 Sunflower oil
11 Red wine
12 Bleach
13 Soft soap
14 Coffee
15 Denatured ethanol
16 Hydrogen peroxide
17 10% ammonia solution

TABLE II

Change after 300 cycles

| | Woodchip | | | |
|---|---|---|---|---|
| Abrasive | wallpaper | Vaporex | Plättli | Kertala |
| 1 | 0 | 0 | 0 | 0 |
| 2 | 2 | 0 | 0 | 0 |
| 3 | 1 | 1 | 0 | 0 |
| 4 | 3 | 1 | 0 | 0 |
| 5 | 4 | 2 | 3 | 4 |
| 6 | 2 | 3 | 0 | 0 |
| 7 | 4 | 3 | 4 | 4 |

1. Sponge orange
2. Sponge blue
3. Brush soft
4. Brush hard
5. Sponge green
6. Steel wool
7. P240 abrasive paper

1. Tile structure having a first carrier layer (1) and a surface layer (2), wherein the surface layer (2) comprises a network of cured organic polysilazanes and wherein the tile structure as a whole is in rollable form.

2. Tile structure according to claim 1,
characterised in that
a decorative layer (4) is provided on the side of the first carrier layer (1) that is remote from the surface layer (2).

3. Tile structure according to claim 2,
characterised in that
a second carrier layer (5) is provided on the side of the decorative layer (4) that is remote from the first carrier layer (1).

4. Tile structure according to claim 1,
characterised in that
at least a second carrier layer (5) is provided on the side of the first carrier layer (1) that is remote from the surface layer (2).

5. Tile structure according to claim 1,
characterised in that
a nano-ceramic layer (3) is provided between the first carrier layer (1) and the surface layer (2).

6. Tile structure according to claim 1,
characterised in that
a decorative layer (4) is provided between the first carrier layer (1) and the surface layer (2).

7. Tile structure according to claim 5,
characterised in that
a decorative layer (4) is provided between the first carrier layer (1) and the nano-ceramic layer (3).

8. Tile structure according to claim 1,
characterised in that
an insulating layer and/or a third carrier layer are provided as further layers.

9. Tile structure according to claim 1,
characterised in that
the first carrier layer (1) and/or the at least a second or third carrier layer (5) consists of or contains a polymer, ceramic, cellulose, glass and/or metal material,
wherein the metal is preferably aluminium, copper, chromium, nickel, zinc, titanium, vanadium, magnesium, iron and/or steel and/or alloys containing one or more of those metals, and
wherein the polymer is preferably a polycarbonate, polymethyl methacrylate, polyether ketone, polyamide, polyethylene terephthalate, polyvinyl chloride, a polyethylene, polypropylene, polystyrene, polyolefin, particularly preferably a flexible polyolefin, or a combination of one or more of those polymers, or the carrier layer (1, 5) is a nonwoven or a combination of one or more of those materials.

10. Tile structure according to claim 1,
characterised in that
the nano-ceramic layer (3) is an SiOx layer.

11. Tile structure according to claim 1,
characterised in that
the tile structure is selected from the following combinations:
a)
surface layer (2)
first carrier layer (1), preferably of aluminium, polycarbonate or flexible polyolefin;
b)
surface layer (2)
nano-ceramic layer (3), preferably of SiOx
first carrier layer (1), preferably of aluminium, polycarbonate or flexible polyolefin;
c)
surface layer (2)
decorative layer (4)
first carrier layer (1), preferably of aluminium, polycarbonate or flexible polyolefin;
d)
surface layer (2)
first carrier layer (1) of a transparent or semi-transparent material, preferably of polycarbonate or flexible polyolefin
decorative layer (4);
e)
surface layer (2)
nano-ceramic layer (3), preferably of SiOx
decorative layer (4)
first carrier layer (1), preferably of aluminium, polycarbonate or flexible polyolefin;
f)
surface layer (2)
nano-ceramic layer (3), preferably of SiOx
first carrier layer (1) of a transparent or semi-transparent material, preferably of polycarbonate or flexible polyolefin
decorative layer (4)
second carrier layer (5), preferably of aluminium, polycarbonate, a nonwoven material or flexible polyolefin, it preferably being formed of a different material from the first carrier layer (1);
g)
surface layer (2)
first carrier layer (1) of a transparent or semi-transparent material, preferably of polycarbonate or flexible polyolefin
decorative layer (4)
second carrier layer (5), preferably of aluminium, polycarbonate, a nonwoven material or flexible polyolefin, it preferably being formed of a different material from the first carrier layer (1).

12. Tile structure according to claim 1,
characterised in that
the surface layer (2) has a thickness of at least 1 μm, preferably from 2 to 20 μm, the nano-ceramic layer (3) has a thickness of at least 1 μm, preferably from 3 to 15 μm, the first and/or second carrier layer (1, 5) has a thickness of in each case from 100 to 200 μm, and the total thickness of the tile structure is from 300 to 1000 μm, preferably from 400 to 600 μm.

13. Tile structure according to claim 1,
characterised in that
the cured organic polysilazane network of the surface layer (2) has the general structural formula (1), the polymer chains of which are composed alternately of silicon and nitrogen atoms
—(SiR′R″—NR′″)n- (1)
wherein R′, R″, R′″ independently of one another represent hydrogen or an optionally substituted alkyl, aryl, vinyl or (trialkoxysilyl)alkyl radical, with the proviso that all the radicals R′, R″ and R′″ do not simultaneously represent hydrogen, wherein n is an integer and n is such that the polysilazane has a number-average molecular weight of from 150 to 150,000 g/mol.

14. Process for the production of a rollable tile structure according to claim 1, having the following process steps:
provision of a first carrier layer (1); and
application of a surface layer (2) to the first carrier layer (1);
provision of a first carrier layer (1); and
application of a surface layer (2) to the first carrier layer (1);
wherein the surface layer (2) is produced from a cured organic polysilazane network and the tile structure as a whole is in rollable form.

15. Process according to claim 14,
characterised in that
at least a second carrier layer (5), optionally in conjunction with a nano-ceramic layer (3) and/or a decorative layer (4), is applied to the side of the first carrier layer (1) that is remote from the surface layer (2).

16. Use of a rollable tile structure according to claim 1 in the production of a tiled covering on walls, ceilings and/or floors.

17. Use of a surface layer (2) comprising a cured organic polysilazane network in the production of a rollable tile structure according to claim 1.
